(19) United States
(12) Patent Application Publication
(10) Pub. No.: US 2002/0014843 A1
(43) Pub. Date: Feb. 7, 2002

(54) Discharge lamp for dielectrically impeded discharge

(76) Inventor: Silke Reber, Hohenstrasse (DE)

Correspondence Address: FULBRIGHT & JAWORSKI, LLP, 666 FIFTH AVE, NEW YORK, NY, 10103-3198, US

(21) Appl. No.: 09/855,420

(22) Filed: May 15, 2001

(30) Foreign Application Priority Data
May 31, 2000 (DE) 100 26 781.5-33

(51) Int. Cl. H01J 17/04; H01J 61/04

(52) U.S. Cl. 313/631; 313/491

(57) ABSTRACT

A discharge lamp for dielectrically impeded discharge has a discharge vessel substantially in the form of a hollow cylinder whose discharge chamber is separated from at least one electrode by a dielectric; on the outer surface of the discharge chamber a spiral-shaped electrode in the form of a ribbon is disposed, which permits rays to pass through it, while on the outer surface of the discharge vessel facing inward toward the cylinder axis a second electrode is provided which is at least partially surrounded by the hollow-cylindrical surface. The surface covered by the first electrode corresponds to no more than 10% of the external surface of the discharge chamber.

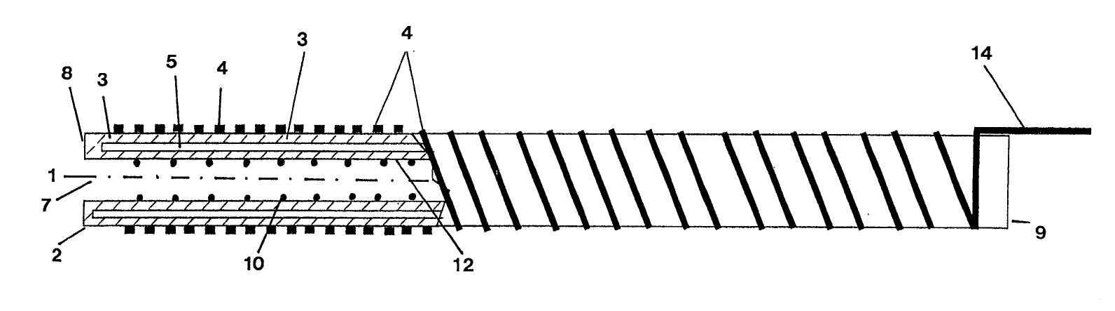

The discharge chamber comprises on its inner side a hollow space configured as a flow passage which is surrounded by the second electrode. The flow passage is provided in order to carry a liquid coolant—preferably deionized water.

The invention relates to a discharge lamp for dielectrically impeded discharge having a discharge vessel substantially in the form of a hollow cylinder with an outer surface and a surface facing the cylinder axis, the discharge chamber of which is separated from at least one electrode by a dielectric, at least one electrode being disposed on the outer surface of the discharge vessel and permitting rays to pass through it.

EP 0 363 832 A1 has disclosed a high-power ultraviolet radiator in which the electrodes consist of wires which are embedded in glass as dielectric. The dielectric is spaced between two plates transparent to ultraviolet light. The discharge chambers are filled with a gas filling which emits radiation under discharge conditions, sliding discharges forming on the dielectric surface between every two adjacent electrode wires. This is a simple and economical design of high-power radiators with a high ultraviolet yield.

In DE 198 44 721 A1 a discharge lamp for dielectrically impeded discharge is disclosed, which contains a vessel filled with a discharge medium; the discharge lamp has a cathode of strip shape, a strip-shaped anode, and a dielectric layer between at least the anode and the discharge medium, the anode being of an undulating configuration, so that the distance between the cathode and the anode is modulated by the undulating shape.

It proves to be especially advantageous that an undulating form of the electrode(s) in contrast to electrode structures known in the literature having nose-like, separate projections is substantially more favorable capacitively , because between the electrode strips definitely greater intervals can be present between the electrode strips than the distance required for electrode configuration reduced in this manner, less idle currents occur in operation, so that the input apparatus necessary for the operation of the discharge lamp can be made smaller, thus saving costs, bulk and weight. Furthermore, in the case of running lower capacities, steeper pulse flanks and thus generally better pulse shapes can be achieved.

This involves a comparatively expensive electrode configuration, also from the production viewpoint.

Furthermore, U.S. Pat. No. 6,666,028 has disclosed a discharge lamp with dielectrically impeded discharge, which has a discharge vessel with a cylindrical double tube, an outer tube being coaxial with an inner tube and an outer electrode being on the outer surface of the outer tube. An inner electrode is disposed on the inside surface of the inner tube which is filled with a discharge gas for the formation of excimer molecules by dielectrically impeded discharge. The inner electrode is a tubular part which has a slot running axially over its entire length. In a preferred embodiment of the discharge lamp the inner electrode is held in tight contact with the inner surface of the tube by a spirally wound spring. The inner electrode is connected to a power supply by the spring.

This is a comparatively complex electrode structure.

Also there is disclosed in EE 195 43 342 a method for body irradiation with ultraviolet rays wherein an incoherent excimer radiation is produced in the wavelength range of 300 to 350 nm, preferably at 300 nm; in a coaxial arrangement a hollow cylindrical transparent dielectric is provided which has on its outer surface a radiation-permeable mesh-like metal electrode, and in the interior a rod-like inner electrode of tungsten running along the cylinder axis. The discharge chamber enclosed by the annular jacket-like dielectric contains a xenon halide filling—preferably a xenon chloride filling—with a cold fill pressure ranging from 500 to 1500 mbar; an alternating voltage applied between the inner and outer electrode can be adapted to the purpose of the body irradiation, e.g, tanning, by modulation with a pulse duty ratio.

In conventional external electrodes for dielectrically impeded discharge, a certain irregularity of the distance between dielectric and electrode has proven problematical, so that if the support of the electrode is not correct, ablation of metal or sputtering can occur on the external surface of the discharge vessel as dielectric, and coiling is created by metallic deposits or metal ablation which interferes with outwardly emitted radiation. The invention is addressed to the problem of preventing deposits on the discharge vessel by micro-discharges, so that no metal ablation or cathodic sputtering processes can occur.

The problem is solved in that the discharge vessel has on at least a portion of its eternal surface a spiral-like first electrode, while a second electrode is disposed at least partially inside of the discharge vessel.

Advantageous embodiments of the invention are given in claims 2 to 10.

The discharge vessel advantageously consists of quartz glass, so that even short-wavelength UV radiation—preferably radiation in the 172 nm wavelength range—can issue from the discharge chamber.

The first electrode is preferably configured as a ribbon whose width ranges from 2 to 3 mm, the outer diameter of the discharge vessel being in the range of 15 to 40 mm. In a preferred embodiment the first electrode covers less than 10% of the outside surface of the discharge chamber. At the same time, due to its spring-like property, the spiral-shaped electrode lies directly on the outer surface of the outer quartz tube surrounding the discharge chamber as dielectric as part of the discharge vessel. Advantageously, a full-surface contact between the metal electrode and the quartz glass surface is assured. This embodiment promotes the input of energy into the plasma in the discharge chamber and reduces micro-discharges in the atmosphere surrounding the electrode. The quartz tube inwardly defining the discharge vessel is provided preferably as a passage carrying a coolant. The second electrode inserted in this inner part of the quartz tube is urged against the inner quartz tube surface by spring force, like the first electrode.

The first electrode consists preferably of a stainless steel ribbon. The second electrode preferably also consists of stainless steel and is configured as a spiral.

The comparatively minor shadowing produced by the first electrode proves especially advantageous.

The subject matter of the invention is further explained below with the aid of the appended FIGURE.

The FIGURE shows schematically, in a longitudinal section in part, a side elevation of a discharge lamp whose discharge vessel is of substantially hollow cylindrical shape.

In the left part of the figure can be seen a schematic longitudinal section along the axis 1 of the discharge vessel 2 of hollow cylindrical shape, with a discharge chamber 5. The hollow cylinder consists preferably of quartz glass. On the external surface 3 of the hollow cylindrical discharge vessel 2 is a ribbon-like spiral, urged directly [against it] by spring tension, as the first electrode 4, whose surface coverage is less than 10% of the entire external surface; on account of the tensional and full-surface contact of the first electrode 4, no micro-discharges can form due to any gap between the external electrode 4 and the dielectric of the discharge vessel 2. The hollow cylindrical discharge vessel 2 is sealed near the ends 8 and 9 of the hollow cylinder, so that a previous filling of gas cannot escape; preferably a noble gas or noble gas mixture or halogen-noble gas mixture is preferably used as the gas filling.

The hollow space 7 surrounding the longitudinal axis 1 has a second electrode 10 placed directly on the external surface 12 facing the axis of the discharge vessel 2, a coolant flowing through the hollow space 7 along the axis 1. The second electrode 10 in the hollow space is likewise configured as a spiral; it consists preferably of stainless steel.

Deionized water which has a relatively high dielectric constant is used preferably as coolant (Er ≈80).

Due to the internal cooling of the hollow space 7 a high energy input is possible, while the radiation produced in the discharge chamber 5 issues through the external surface 3 of the discharge vessel 5 covered by the first electrode 4.

For the connection of the first electrode 4 to a power supply, a conductor 14 connected to it tightly, electrically and mechanically, is provided. The connection of the second electrode 10 is performed in a similar manner.

The power supply is provided preferably by feeding pulsed or continuous high frequency.

1. Discharge lamp for dielectrically impeded discharge, with a discharge vessel configured substantially as a hollow cylinder with an external surface, and an external surface facing the cylinder axis, whose discharge chamber is separated from at least one electrode by a dielectric, at least one electrode being disposed on the external surface of the discharge vessel and permitting the outward passage of radiation, characterized in that the discharge vessel (2) has on at least a portion of its external surface (3) a spirally formed first electrode (1), a second electrode (10) being disposed at least partially within the discharge vessel (2).

2. Discharge lamp according to claim 1, characterized in that the discharge vessel (2) consists of quartz glass.

3. Discharge lamp according to claim 1 or 2, characterized in that the first electrode (4) is configured as ribbon.

4. Discharge lamp according to any one of claims 1 to 3, characterized in that the area covered by the first electrode (4) covers a maximum 10% of the external surface (3) of the discharge vessel (2).

5. Discharge lamp according to any one of claims 1 to 4, characterized in that the first electrode (4) lies tensionally directly on the external surface of the discharge vessel (2).

6. Discharge lamp according to any one of claims 1 to 5, characterized in that the first electrode (4) is urged by spring force on the external surface (3) of the discharge vessel (2).

7. Discharge lamp according to any one of claims 1 to 6, characterized in that the discharge vessel (2) comprises at least partially a hollow space (7) as a flow passage which is surrounded by the second electrode (10).

8. Discharge lamp according to claim 7, characterized in that the second electrode (10) is configured as a spiral which lies directly on the external surface (12) of the discharge vessel, which is directed toward the axis.

9. Discharge lamp according to claim 6 or 7, characterized in that the hollow space (7) configured as a flow passage is provided to carry a coolant.

10. Discharge lamp according to claim 9, characterized in that deionized water is provided as coolant.
